(19) United States
(12) Patent Application Publication
(10) Pub. No.: US 2006/0093799 A1
(43) Pub. Date: May 4, 2006

(54) Wired circuit board

(75) Inventors: Yasufumi Miyake, Osaka (JP); Kyouyuu Jo, Osaka (JP); Toshiki Naito, Osaka (JP); Yutaka Aoki, Osaka (JP)

Correspondence Address: AKERMAN SENTERFITT, 801 PENNSYLVANIA AVENUE N.W., SUITE 600, WASHINGTON, DC, 20004, US

(73) Assignee: Nitto Denko Corporation, Osaka (JP)

(21) Appl. No.: 11/259,028

(22) Filed: Oct. 27, 2005

(30) Foreign Application Priority Data
Nov. 4, 2004 (JP) JP2004-320937

(51) Int. Cl. B32B 3/00; B32B 18/00

(52) U.S. Cl. 428/209; 428/210

(57) ABSTRACT

A wired circuit board having good alkali resistance as well as good flexibility. The wired circuit board comprising an insulating base layer 21, a conductor layer 22 laminated on the insulating layer 21, and an insulating cover layer 23 formed on the insulating base layer 21 to cover the conductor layer 22, wherein at least the insulating base layer 21 is formed from a resin having a repeated unit expressed by at least either the following general formula (1) or (2), and a weight-average molecular weight in the range of 0.1×10⁵ to 1.5×10⁵:
Chemical Formula (1) 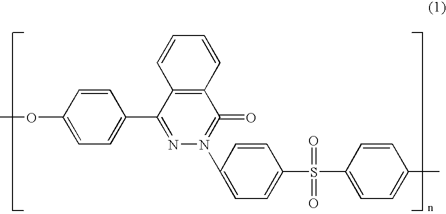 (n represents a degree of polymerization)
Chemical Formula (2) 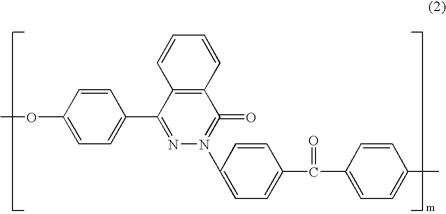 (m represents a degree of polymerization)

### CROSS REFERENCE TO RELATED APPLICATION

This application claims priority from Japanese Patent Application No. 2004-320937, filed on Nov. 4, 2004, the contents of which are herein incorporated by reference in their entirely.

### BACKGROUND OF THE INVENTION

1. Field of the Invention

The present invention relates to a wired circuit board and, more particularly, to a wired circuit board having a good alkali resistance, such as an alkali-resistant flexible wired circuit board.

2. Description of the Prior Art

The wired circuit board, such as the flexible wired circuit board, usually has the structure wherein a conductive pattern of copper wiring and the like is formed on an insulating base layer and an insulating cover layer is formed on the insulating base layer to cover the conductive pattern.

The flexible wired circuit board mounting electronic components thereon is used in various environments. Accordingly, the flexible wired circuit board is required to have various kinds of physicality, including not only flexibility but also heat resistance, moisture resistance, alkali resistance, and so on, and also is required to be produced at low costs.

In this flexible wired circuit board, polyimide is generally used as the insulating material used for forming the insulating base layer and the insulating cover layer in terms of its excellent flexibility and heat resistance. In addition to polyimide, various kinds of resins, including polyparabanic acid, polyester, polyethylene naphthalate, polyether sulfone, polyether imide, and polyether ketone, are used, as is known (Cf. JP Laid-open (Unexamined) Patent Publication No. 2001-234153, for example).

Any of the resins cited above are poor in alkali resistance, however. On the other hand, for example polyphenylene sulfide and the like exhibits good alkali resistance, as is known, but, since it is recrystallized by heating and cooling, it cannot obtain sufficient flexibility. Due to this, polyphenylene sulfide is unsuitable for the insulating material of the flexible wired circuit board.

### SUMMARY OF THE INVENTION

It is an object of the present invention to provide a wired circuit board having good alkali resistance as well as good flexibility.

The present invention provides a novel wired circuit board comprising an insulating layer and a conductor layer laminated on the insulating layer, wherein the insulating layer is formed from resin having a repeated unit expressed by at least either the following general formula (1) or (2), and a weight-average molecular weight in the range of 0.1×10⁵ to 1.5×10⁵:
Chemical Formula (1) 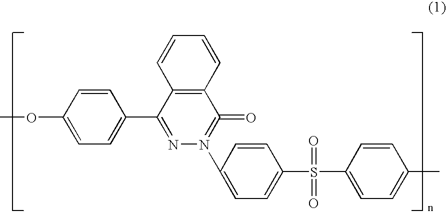
(n represents a degree of polymerization)
Chemical Formula (2) 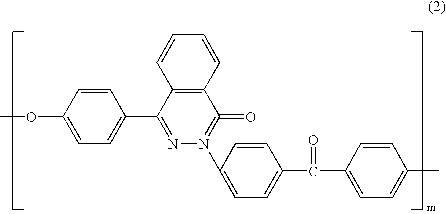
(m represents a degree of polymerization)

The present invention provides a novel wired circuit board comprising a first insulating layer, a conductor layer laminated on the first insulating layer, and a second insulating layer interposed between the first insulating layer and the conductor layer, wherein the second insulating layer is formed from resin having a repeated unit expressed by at least either the following general formula (1) or (2), and a weight-average molecular weight in the range of 0.1×10⁵ to 1.5×10⁵:
Chemical Formula (1) 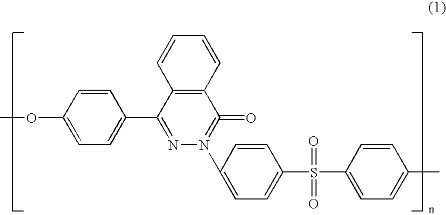
(n represents a degree of polymerization)
Chemical Formula (2) 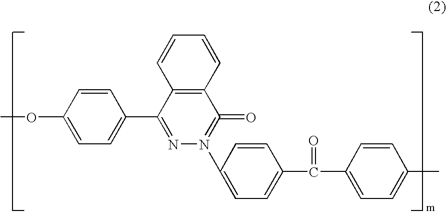
(m represents a degree of polymerization)

In the wired circuit board above, it is preferable that the first insulating layer is formed from polyimide.

According to the wired circuit board of the present invention, since the insulating layer, which includes the second insulating layer, is formed from a resin having a repeated unit expressed by at least either the general formula (1) or (2) given above and a weight-average molecular weight in the range of 0.1×10⁵ to 1.5×10⁵, there can be provided the wired circuit board having good alkali resistance as well as good flexibility.

### BRIEF DESCRIPTION OF THE DRAWINGS

In the drawings:

FIG. 1 is a sectional view showing a principal part of an embodiment (a single-sided flexible wired circuit board) of a wired circuit board of the present invention,

FIG. 2 is a sectional view showing a principal part of an embodiment (a double-sided flexible wired circuit board) of a wired circuit board of the present invention,

FIG. 3 is a sectional view showing a principal part of an embodiment (a single-sided flexible wired circuit board wherein an insulating base layer and an insulating cover layer are each formed to have a double-layer structure) of a wired circuit board of the present invention, and

FIG. 4 is a sectional view showing a principal part of an embodiment (a double-sided flexible wired circuit board wherein an insulating base layer and an insulating cover layer are each formed to have a double-layer structure) of a wired circuit board of the present invention.

### DETAILED DESCRIPTION OF THE PREFERRED EMBODIMENT

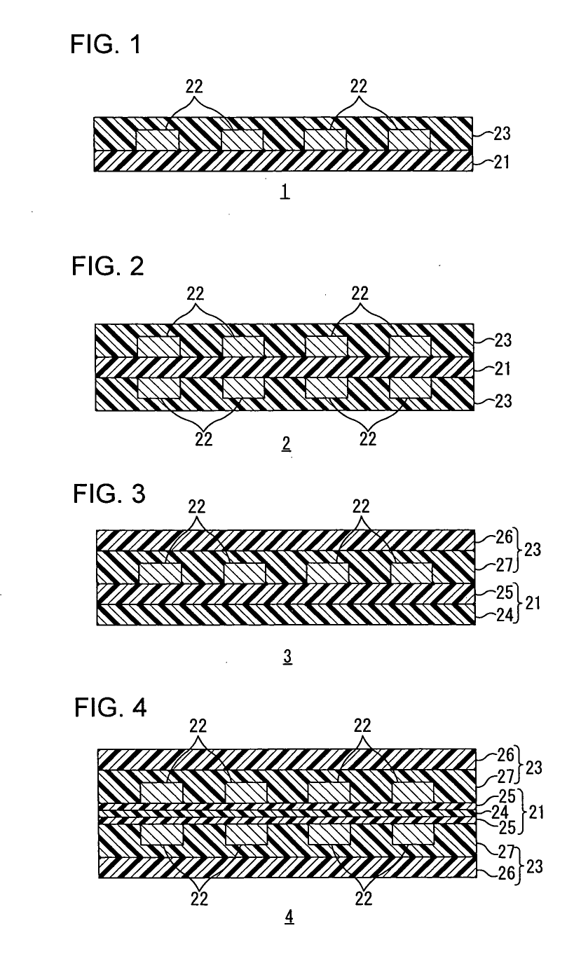

FIGS. 1 and 2 are sectional views showing a principal part of an embodiment of a wired circuit board of the present invention,

In FIG. 1, the wired circuit board 1 is a single-sided flexible wired circuit board having a conductive pattern 22 formed on an either side of an insulating base layer 21. To be more specific, this wired circuit board 1 is shaped like a band plate and comprises an insulating base layer 21 formed as an insulating layer, a conductor layer 22 formed on a surface of the insulating base layer 21 (on one side thereof) and formed as a wired circuit pattern, and an insulating cover layer 23 formed on a surface of the insulating base layer 21 to cover the conductor layer 22.

In FIG. 2, the wired circuit board 2 is a double-sided flexible wired circuit board having a conductive pattern 22 formed on both sides of an insulating base layer 21. To be more specific, this wired circuit board 2 is shaped like a band plate and comprises an insulating base layer 21, conductor layers 22 formed on a front surface of the insulating base layer 21 and on a back surface of the same (on the other side thereof), respectively, and insulating cover layers 23 formed on a front surface of the insulating base layer 21 and on a back surface of the same (on the other side thereof), respectively, to cover the respective conductor layers 22.

In the wired circuit board shown in FIG. 1 and the wired circuit board shown in FIG. 2, at least any one of the insulating base layer 21 and the insulating cover layer(s) 23 is formed from polyphthalazinon resin having a repeated unit expressed by any one of the following general formulas (1), (2), and (3):
Chemical Formula (1) 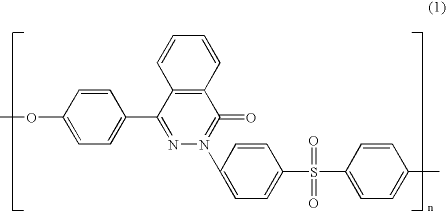
(n represents a degree of polymerization)
Chemical Formula (2) 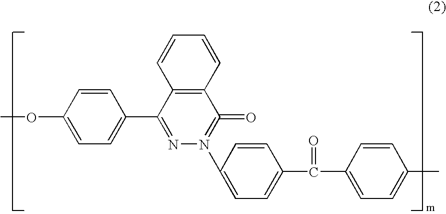
(m represents a degree of polymerization)
Chemical Formula (3) 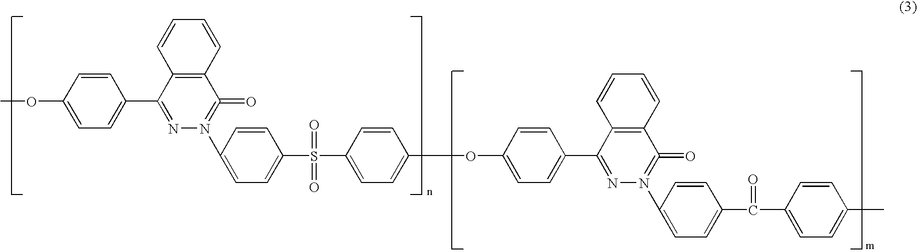
(n and m represent a degree of polymerization)

To be more specific, the resin having the repeated unit expressed by the general formula (1) is poly(phthalazinon ether sulfone), and the resin having the repeated unit expressed by the general formula (2) is poly(phthalazinon ether ketone). The resin having the repeated unit expressed by the general formula (3) is poly(phthalazinon ether sulfone ketone) of block copolymer or random copolymer having a repeated unit expressed by the general formula (1) and the general formula (2) given above.

The polyphthalazinon resins cited above usually have a weight-average molecular weight in the range of 0.1×10⁵ to 1.5×10⁵. The weight-average molecular weight of the resin having a repeated unit expressed by the general formula (1) is preferably in the range of 0.3×10⁵ to 1.3×10⁵. The weight-average molecular weight of the resin having a repeated unit expressed by the general formula (2) is preferably in the range of 0.5×10⁵ to 1.5×10⁵. The weight-average molecular weight of the resin having a repeated unit expressed by the general formula (3) is preferably in the range of 0.1×10⁵ to 1.0×10⁵. These polyphthalazinon resins are commercially available.

The polyphthalazinon resins are preferably used for the insulating base layer, or further preferably for both the insulating base layer and the insulating cover layer.

When the polyphthalazinon resin is used solely for either the insulating base layer 21 or the insulating cover layer 23, some different resin, such as, for example, polyimide and polyether imide, than the polyphthalazinon resins, (hereinafter it is referred to as “the different resin”) is used for the other of the insulating base layer 21 and the insulating cover layer 23. Preferably, polyimide is used for the other.

The insulating base layer 21 and the insulating cover layer 23 preferably have a thickness of 12.5-50 μm.

No particular limitation is imposed on the conductor layer 22, as long as it is electrically conductive. For example, the conductor layer 22 is formed from metal, including copper, chromium, nickel, aluminum, stainless steel, copper-beryllium, phosphor bronze, iron-nickel, and alloys thereof, and is formed in the form of the wired circuit pattern for any intended purpose. Preferably, the conductor layer 22 has a thickness of 12-35 μm.

In the wired circuit board shown in FIG. 1, there are provided two different aspects by way of example: a first aspect that polyphthalazinon resin is used for both the insulating base layer 21 and the insulating cover layer 23, and a second aspect that polyphthalazinon resin is used for one of the insulating base layer 21 and the insulating cover layer 23, while on the other hand, the different resin is used for the other of them.

In the wired circuit board shown in FIG. 2, there are provided four different aspects by way of example: a first aspect that the polyphthalazinon resin is used solely for the insulating base layer 21 and both of the insulating cover layers 23, a second aspect that the polyphthalazinon resin is used for the insulating base layer 21 and one of the insulating cover layers 23, and the different resin is used for the other of the insulating cover layers 23, a third aspect that the polyphthalazinon resin is used for both of the insulating cover layers 23, and the different resin is used for the insulating base layer 21, and a fourth aspect that the polyphthalazinon resin is used for any one of the insulating cover layers 23, and the different resin is used for the insulating base layer 21 and the other of the insulating cover layers 23.

No particular limitation is imposed on the method for producing the wired circuit board 1 shown in FIG. 1. For example, it can be produced using the subtractive process.

Specifically, a metal foil for forming the conductor layer 22 is prepared, first, and, then, varnish of the resin for forming the insulating base layer 21 is coated over a surface of the metal foil and then dried, thereby forming the insulating base layer 21 of a film of resin thereon. As a result of this, a two-layer base material having the metal foil laminated on the one side of the insulating base layer 21 is obtained.

The varnish of the resin can be prepared, for example, by dissolving the resin cited above (i.e., the polyphthalazinon resin or the different resin) in an organic solvent, such as, for example, N-methylpyrrolidone, dimethylacetamide, or a mixed solvent thereof so that the resin can contain a concentration of e.g. 10-20 weight %.

The coating of the varnish of the resin over the metal foil can be performed by a known method using an applicator, for example. In the subsequent drying process, the varnish of the resin is heated at e.g. 150-200° C. for 10-20 hours. After dried, the varnish of the resin can be subjected to an after-cure at 200-320° C. for 20-30 minutes, if necessary. The after-cure can remove the remaining solvent and can also prevent being foamed in the laminating step.

Then, the metal foil of the two-layer base material is formed in a wired circuit pattern by the subtractive process and thereby the conductor layer 22 is formed. In the subtractive process, after an etching resist having a corresponding pattern to the wired circuit pattern is formed on the metal foil, the metal foil exposed from the etching resist is etched. Thereafter, the etching resist is removed by etching or by stripping. The etching resist is formed by a known patterning process using a dry film photo-resist and the like.

Thereafter, the varnish of the resin for forming the insulating cover layer 23 is coated over the surface of the insulating base layer 21 to cover the conductor layer 22 and then dried, thereby forming the insulating cover layer 23 of a film of resin thereon. The same conditions and the same processes as those for forming the insulating base layer 21 are used for forming the insulating cover layer 23.

If necessary, the insulating cover layer 23 may be bored to form terminal portions and the like by a known proper method, such as by drilling. The wired circuit board 1 is produced in the manner described above.

No particular limitation is imposed on the method for producing a wired circuit board 2 shown in FIG. 2. For example, it can be produced using the subtractive process.

Specifically, in conformity with the producing method of the wired circuit board 1 shown in FIG. 1, two two-layer base materials, each having the insulating base layer 21 laminated on the metal foil, are obtained, first. Then, these two two-layer base materials 21 are bonded together to obtain a double-sided base material having the metal foils laminated on both sides of the insulating base layer 21.

The bonding together of the two two-layer base materials for lamination is provided by hot pressing, for example. The hot pressing is performed for example in the following conditions: Temperature of 300-380° C., Pressure of 1-3 MPa, and Pressing time of 15-30 minutes.

Thereafter, the metal foils of the double-sided base material are each formed in the wired circuit pattern by the subtractive process in the same manner as in the abovesaid embodiment, to form the conductor layers 22.

Then, the varnish of the resin for forming the insulating cover layers 23 is coated over the front surface and the back surface of the insulating base layer 21 and dried, thereby forming the insulating cover layer 23 of a film of resin thereon. The same conditions and the same processes as those for forming the insulating base layer 21 are used for forming the insulating cover layer 23.

If necessary, the respective insulating cover layers 23 may be bored to form terminal portions and the like by a known proper method, such as by drilling. The wired circuit board 2 is produced in manner described above.

FIGS. 3 and 4 are sectional views showing a principal part of an embodiment of a wired circuit board of the present invention,

In a wired circuit board 3 shown in FIG. 3 and a wired circuit board shown in FIG. 4, the insulating base layer 21 and the insulating cover layer 23 are each formed in the form of a double-layer structure.

Specifically, the insulating base layer 21 comprises a first insulating base layer 24 formed as the first insulating layer, and a second insulating base layer 25 interposed between the first insulating base layer 24 and the conductor layer 22 and formed as the second insulating layer.

The insulating cover layer 23 comprises a first insulating cover layer 26 formed as the first insulating layer, and a second insulating cover layer 27 interposed between the first insulating cover layer 26 and the conductor layer 22 and formed as the second insulating layer.

A wired circuit board 3 shown in FIG. 3 is a single-sided flexible wired circuit board corresponding to that of FIG. 1. To be more specific, this wired circuit board 3 is shaped like a band plate and comprises the insulating base layer 24, the second insulating base layer 25 formed on a surface of the first insulating base layer 24, the conductor layer 22 formed in the form of the wired circuit pattern on a surface of the second insulating base layer 25, the second insulating cover layer 27 formed on a surface of the second insulating base layer 25 to cover the conductor layer 22, and the first insulating cover layer 26 formed on a surface of the second insulating cover layer 27.

A wired circuit board 4 shown in FIG. 4 is a double-sided flexible wired circuit board corresponding to that of FIG. 2. To be more specific, this wired circuit board 4 is shaped like a band plate and comprises the insulating base layer 24, the second insulating base layers 25 formed on a front surface and a back surface of the first insulating base layer 24, respectively, the conductor layers 22 formed in the form of the wired circuit pattern on surfaces of the second insulating base layers 25, respectively, the second insulating cover layer 27 formed on surfaces of the second insulating base layer 25, respectively, to cover the conductor layers 22, and the first insulating cover layers 26 formed on surfaces of the second insulating cover layers 27, respectively.

In the wired circuit board 3 shown in FIG. 3 and the wired circuit board 4 shown in FIG. 4, at least one insulating layer of the first insulating base layer 24, the second insulating base layer 25, the first insulating cover layer 26, and the second insulating cover layer 27 is formed from the polyphthalazinon resin, and the remaining insulating layer(s) (the other insulating layer(s) than the insulating layer(s) formed from the polyphthalazinon resin) are formed from the different resin, or preferably from polyimide.

In order to provide improved alkali resistance, at least any one of the second insulating base layer 25 and the second insulating cover layer 27 which are in contact with the conductor layer 22 is preferably formed from polyphthalazinon resin. Further preferably, both of the second insulating base layer 25 and the second insulating cover layer 27 which are in contact with the conductor layer 22 are formed from polyphthalazinon resin.

On the other hand, at least any one of the first insulating base layer 24 and the first insulating cover layer 26 which are not in contact with the conductor layer 22 is preferably formed from polyimide. Further preferably, both of the first insulating base layer 24 and the first insulating cover layer 26 which are not in contact with the conductor layer 22 are formed from polyimide.

The first insulating base layer 24 and the first insulating cover layer 26 preferably have a thickness of 12.5-25 μm.

The second insulating base layer 25 and the second insulating cover layer 27 preferably have a thickness of 4-25 μm.

The conductor layers 22 are formed in the form of the wired circuit pattern for the intended purpose, as is the case with the above. The conductor layers 22 preferably have a thickness of 12-35 μm.

In the wired circuit board 3 shown in FIG. 3, there are provided two different aspects by way of example. Specifically, a first aspect that the polyphthalazinon resin is used for any one of the second insulating base layer 25 and the second insulating cover layer 27 and the different resin is used for the other of them, and a second aspect that the polyphthalazinon resin is used for both of the second insulating base layer 25 and the second insulating cover layer 27 and the different resin is used for the other of them. Preferably, the polyphthalazinon resin is used for the second insulating base layer 25 and the different resin, or preferably polyimide, is used for the first insulating base layer 24. This aspect can provide the result of providing improved alkali resistance, while ensuring dimensional stability.

In the wired circuit board 4 shown in FIG. 4, there are provided two different aspects by way of example. Specifically, a first aspect that the polyphthalazinon resin is used for any one of both of the second insulating base layers 25 and both of the second insulating cover layers 27 and the different resin is used for the other of them, and a second aspect that the polyphthalazinon resin is used for both of the both second insulating base layers 25 and the both second insulating cover layers 27 and the different resin is used for the other of them. Preferably, the polyphthalazinon resin is used for each of the second insulating base layers 25 and the different resin, or preferably polyimide, is used for the first insulating base layer 24. This aspect can provide the result of providing improved alkali resistance, while ensuring dimensional stability.

No particular limitation is imposed on the method for producing the wired circuit board 3 shown in FIG. 3. For example, it can be produced in conformity with the producing method of the wired circuit board 1 shown in FIG. 1. Specifically, a metal foil for forming the conductor layer 22 is prepared, first, and, then, varnish of the resin for forming the second insulating base layer 25 is coated over a surface of the metal foil and then dried, thereby forming the second insulating base layer 25 of a film of resin thereon. As a result of this, a two-layer base material having the metal foil laminated on the one side of the second insulating base layer 25 is obtained.

Then, a film of the resin for forming the first insulating base layer 24 is laminated on a surface of the second insulating base layer 25 by hot pressing and the like, to form the first insulating base layer 24, or alternatively, the varnish of the resin for forming the first insulating base layer 24 is coated over the surface of the second insulating base layer 25 and then dried, thereby forming the first insulating base layer 24 thereon.

Then, the metal foil is formed in a wired circuit pattern by the subtractive process and thereby the conductor layer 22 is formed. Thereafter, the varnish of the resin for forming the second insulating cover layer 27 is coated over the surface of the second insulating base layer 25 to cover the conductor layer 22 and then dried, thereby forming the second insulating cover layer 27 of a film of resin thereon.

Thereafter, a film of the varnish of the resin for forming the first insulating cover layer 26 is laminated on a surface of the second insulating cover layer 27 by hot pressing and the like, to form the first insulating cover layer 26, or alternatively, the varnish of the resin for forming the first insulating cover layer 26 is coated over the surface of the second insulating cover layer 27 and then dried, thereby forming the first insulating cover layer 26 thereon.

If necessary, the first insulating cover layer 26 and the second insulating cover layer 27 may be bored to form terminal portions and the like by a known proper method, such as by drilling. The wired circuit board 3 is produced in the manner described above.

No particular limitation is imposed on the method for producing a wired circuit board 4 shown in FIG. 4. For example, it can be produced in conformity with the producing method of the wired circuit board 2 shown in FIG. 2. Specifically, two two-layer base materials, each comprising the second insulating base layer 25 laminated on the metal foil, are obtained, first, in conformity with the producing method of the wired circuit board 3 shown in FIG. 3. Then, these two two-layer base materials 25 are bonded to both sides of the film of the resin for forming the first insulating base layer 24, to obtain a double-sided base material having the metal foils laminated on the surfaces of the second insulating base layers 25, respectively. When the film of resin is previously subjected to the plasma processing by a known method, improved adhesion of the film to the second insulating base layers 25 can be provided.

Thereafter, the metal foils of the double-sided base material are each formed in the wired circuit pattern by the subtractive process in the same manner as in the abovesaid embodiment, to form the conductor layers 22.

Then, the varnish of the resin for forming the second insulating cover layers 27 is coated over the surfaces of the second insulating base layer 25, respectively, and dried, thereby forming the second insulating cover layers 27 of a film of resin thereon, respectively.

Thereafter, a film of the resin for forming the first insulating cover layer 26 is laminated on a surface of each of the second insulating cover layers 27 by hot pressing and the like, to form the first insulating cover layers 26, or alternatively, the varnish of the resin for forming the first insulating cover layer 26 is coated over the surface of each of the second insulating cover layers 27 and then dried, thereby forming the first insulating cover layers 26 thereon, respectively.

If necessary, the first insulating cover layers 26 and the second insulating cover layers 27 may be bored to form terminal portions and the like by a known proper method, such as by drilling. The wired circuit board 4 is produced in the manner described above.

In the wired circuit boards 1, 2, 3, and 4 illustrated above, since the polyphthalazinon resin is used for at least any one of the insulating base layer 21 and the insulating cover layer 23, improved alkali resistance can be provided, while ensuring the flexibility.

According to the wired circuit board of the present invention, as long as the polyphthalazinon resin is used for any of the insulating layers, no particular limitation is imposed on the laminar structure and the number of layers. For example, in the wired circuit board 3 shown in FIG. 3 and the wired circuit board 4 shown in FIG. 4, either the insulating base layer 21 or the insulating cover layer 23 may be formed in a single-layer structure, rather than a two-layer structure. Further, the insulating cover layer 23 may not be provided in the wired circuit boards 1, 2, 3, and 4.

### EXAMPLE

While in the following, the present invention will be described in further detail with reference to Example and Comparative Example.

### Example 1

Poly(phthalazinon ether sulfone) (Equivalent to the general formula (1), Weight-average molecular weight Mw=0.86×10⁵, Name of article: PPES, Available from Dalian Polymer New Material Co., Ltd.) was dissolved in a mixed solvent of N-methylpyrrolidone/dimethylacetamide (a weight ratio of 7/3) to prepare a varnish of the resin containing a concentration of 20 weight %

The varnish thus prepared was coated over a mat surface of an electrolytic copper foil (18 μm thick, JTC foil, Available from Nikko Materials CO., LTD.) by use of the applicator and then dried at 150° C. for twenty minutes, thereby forming an insulating layer having a thickness of 13 μm thereon. Thereafter, the insulating layer thus obtained was subjected to the after-cure at 220° C. for twenty minutes, followed by the after-cure at 320° C. for two minutes, to produce a two-layer base material.

Then, two two-layer base materials were subjected to lamination at 320° C. and 20×9.8 Pa for fifteen minutes by using a hot pressing apparatus, to laminate together the insulating layers.

Then, after an etching resist with a corresponding pattern to a wired circuit pattern was formed on a surface of each of the electrolytic copper foils by using a photoresist, the electrolytic copper foils exposed from the respective etching resists were etched using aqueous ferric chloride. Thereafter, the etching resist was removed by stripping, to form the conductor layers. A double-sided flexible wired circuit board was produced in the manner described above.

### Example 2

Except that Poly(phthalazinon ether ketone) (Equivalent to the general formula (2), Weight-average molecular weight Mw=1.02×10⁵, Name of article: PPEK, Available from Dalian Polymer New Material Co., Ltd.) was used as substitute for poly(phthalazinon ether sulfone), the same method as that of Example 1 was used to obtain a double-sided flexible wired circuit board.

### Example 3

Except that Poly(phthalazinon ether sulfoneketone) (Equivalent to the general formula (3), n:m=1:1, Weight-average molecular weight Mw=0.39×10⁵, Name of article: PPESK, Available from Dalian Polymer New Material Co., Ltd.) was used as substitute for poly(phthalazinon ether sulfone), the same method as that of Example 1 was used to obtain a double-sided flexible wired circuit board.

### Example 4

Poly(phthalazinon ether sulfone) (Equivalent to the general formula (1), Weight-average molecular weight Mw=0.86×10⁵, Name of article: PPES, Available from Dalian Polymer New Material Co., Ltd.) was dissolved in a mixed solvent of N-methylpyrrolidone/dimethylacetamide (a weight ratio of 7/3) to prepare a varnish of the resin containing a concentration of 20 weight %

The varnish thus prepared was coated over a mat surface of an electrolytic copper foil (18 μm thick, JTC foil, Available from Nikko Materials CO., LTD.) by use of the applicator and then dried at 150° C. for twenty minutes, thereby forming an insulating layer having a thickness of 13 μm thereon. Thereafter, the insulating layer thus obtained was subjected to the after-cure at 220° C. for twenty minutes, followed by the after-cure at 320° C. for two minutes, to produce a two-layer base material.

Then, after an etching resist with a corresponding pattern to a wired circuit pattern was formed on a surface of the electrolytic copper foil by using a photoresist, the electrolytic copper foil exposed from the etching resist was etched using aqueous ferric chloride. Thereafter, the etching resist was removed by stripping, to form the conductor layer. A single-sided flexible wired circuit board was produced in the manner described above.

### Example 5

Except that Poly(phthalazinon ether ketone) (Equivalent to the general formula (2), Weight-average molecular weight Mw=1.02×10⁵, Name of article: PPEK, Available from Dalian Polymer New Material Co., Ltd.) was used as substitute for poly(phthalazinon ether sulfone), the same method as that of Example 4 was used to obtain a single-sided flexible wired circuit board.

### Example 6

Except that Poly(phthalazinon ether sulfoneketone) (Equivalent to the general formula (3), n:m=1:1, Weight-average molecular weight Mw=0.39×10⁵, Name of article: PPESK, Available from Dalian Polymer New Material Co., Ltd.) was used as substitute for poly(phthalazinon ether sulfone), the same method as that of Example 4 was used to obtain a single-sided flexible wired circuit board.

### Example 7

Poly(phthalazinon ether sulfone) (Equivalent to the general formula (1), Weight-average molecular weight Mw=0.86×10⁵, Name of article: PPES, Available from Dalian Polymer New Material Co., Ltd.) was dissolved in a mixed solvent of N-methylpyrrolidone/dimethylacetamide (a weight ratio of 7/3) to prepare a varnish of the resin containing a concentration of 20 weight %

The varnish thus prepared was coated over a mat surface of an electrolytic copper foil (18 μm thick, JTC foil, Available from Nikko Materials CO., LTD.) by use of the applicator and then dried at 150° C. for twenty minutes, thereby forming a second insulating layer having a thickness of 3 μm thereon. Thereafter, the insulating layer thus obtained was subjected to the after-cure at 220° C. for twenty minutes, followed by the after-cure at 320° C. for two minutes, to produce a two-layer base material.

A film of polyimide having a thickness of 20 μm (Name of article: UPILEX 20S, Available from Ube Industries, Ltd.) was prepared separately and both sides of the polyimide film were subjected to the plasma processing. The conditions for the plasma processing were as follows: Oxygen concentration: 300 mL/min., Degree of vacuum: 27 Pa, Processing time: two minutes, and Processing condition: 13.56 MHz×1.5 kW.

Then, the second insulating layers of two two-layer base materials, sandwiching the polyimide film of the first insulating layer therebetween, were subjected to lamination at 320° C. and 20×9.8 Pa for fifteen minutes by using a hot pressing apparatus. The double-sided base material having the electrolytic copper foils laminated on the surfaces of the second insulating layers, respectively, was obtained.

Then, after an etching resist with a corresponding pattern to a wired circuit pattern was formed on a surface of each of the electrolytic copper foils by using a photoresist, the electrolytic copper foils exposed from the respective etching resists were etched using aqueous ferric chloride. Thereafter, the etching resists were removed by stripping, to form the conductor layers. A double-sided flexible wired circuit board was produced in the manner described above.

### Example 8

Except that Poly(phthalazinon ether ketone) (Equivalent to the general formula (2), Weight-average molecular weight Mw=1.02×10⁵, Name of article: PPEK, Available from Dalian Polymer New Material Co., Ltd.) was used as substitute for poly(phthalazinon ether sulfone), the same method as that of Example 7 was used to obtain a double-sided flexible wired circuit board.

### Example 9

Except that Poly(phthalazinon ether sulfoneketone) (Equivalent to the general formula (3), n:m=1:1, Weight-average molecular weight Mw=0.39×10⁵, Name of article: PPESK, Available from Dalian Polymer New Material Co., Ltd.) was used as substitute for poly(phthalazinon ether sulfone), the same method as that of Example 7 was used to obtain a double-sided flexible wired circuit board.

### Comparative Example 1

A double-sided base material having a copper foil of 18 μm thick laminated on each side of a film of polyimide used as the insulating layer of 25 μm thick (Name of article: ESPANEX, Available from Nippon Steel Chemical Co., Ltd.) was prepared. Then, after an etching resist with a corresponding pattern to a wired circuit pattern was formed on a surface of each of the electrolytic copper foils by using a photoresist, the copper foils exposed from the respective etching resists were etched using aqueous ferric chloride. Thereafter, the etching resists were removed by stripping, to form the conductor layers. A double-sided flexible wired circuit board was produced in the manner described above.

### Comparative Example 2

A two-layer base material having a copper foil of 18 μm thick laminated on a single side of a film of polyimide used as the insulating layer of 25 μm thick (Name of article: ESPANEX, Available from Nippon Steel Chemical Co., Ltd.) was prepared. Then, after an etching resist with a corresponding pattern to a wired circuit pattern was formed on a surface of the copper foils by using a photoresist, the copper foil exposed from the etching resist was etched using aqueous ferric chloride. Thereafter, the etching resist was removed by stripping, to form the conductor layer. A single-sided flexible wired circuit board was produced in the manner described above.

Evaluation

The alkali resistance and the dimensional stability of the respective wired circuit boards of Examples and Comparative Examples thus obtained were evaluated in the following manner.

1) Evaluation of Alkali Resistance

After the wired circuit boards were dipped in aqueous sodium hydroxide of pH 10 for five hours at 60° C., the visual appearance was evaluated on the basis of the following standards.
◯: No particular problem was observed.
×: Melting of the insulating layer and stripping of the conductor layer were observed.
   2) Evaluation of Dimensional Stability

In conformity with IPC-TM-650, a rate of shrinkage of length of the wired circuit pattern of the conductor layer before etching and a rate of shrinkage of length of the same after etching were measured. The results are shown in TABLE 1.

TABLE 1

| Examples./Comparative. | | Composition of | Composition of | Alkali | Rate of Shrinkage |
|---|---|---|---|---|---|
| Examples. | | Insulating Layer | Conductor Layer | Resistance | Before/After Etching (%) |
| Examples | 1 | PPES | Double-sided | ◯ | 0.4 |
| | 2 | PPEK | Double-sided | ◯ | 0.4 |
| | 3 | PPESK | Double-sided | ◯ | 0.4 |
| | 4 | PPES | Single-sided | ◯ | 0.4 |
| | 5 | PPEK | Single-sided | ◯ | 0.4 |
| | 6 | PPESK | Single-sided | ◯ | 0.4 |
| | 7 | PPES/Polyimide/ | Double-sided | ◯ | 0.1 |
| | | PPES | | | |
| | 8 | PPEK/Polyimide/ | Double-sided | ◯ | 0.1 |
| | | PPEK | | | |
| | 9 | PPESK/Polyimide/ | Double-sided | ◯ | 0.1 |
| | | PPESK | | | |
| Compara. | 1 | Polyimide | Double-sided | X | 0.05 |
| Examples | 2 | Polyimide | Single-sided | X | 0.05 |

As seen from TABLE 1, the Examples were good in alkali resistance and dimensional stability, as compared with the Comparative, Examples. Of the Examples, the Examples 7-9 having a polyimide film in the form of the first insulating layer interposed between each of the second insulating layers were good in dimensional stability at the etching, as compared with the other Examples 1-6.

While the illustrative embodiments of the present invention are provided in the above description, such is for illustrative purpose only and it is not to be construed restrictively. Modification and variation of the present invention that will be obvious to those skilled in the art is to be covered by the following claims.

What is claimed is:

1. A wired circuit board comprising an insulating layer and a conductor layer laminated on the insulating layer, wherein the insulating layer is formed from resin having a repeated unit expressed by at least either the following general formula (1) or (2), and a weight-average molecular weight in the range of 0.1×10⁵ to 1.5×10⁵:
Chemical Formula (1) 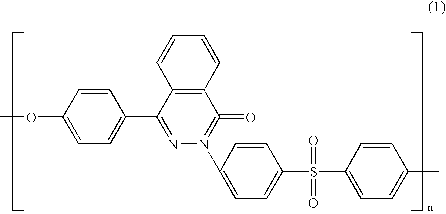
(n represents a degree of polymerization)
Chemical Formula (2) 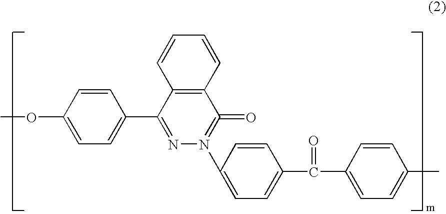
(m represents a degree of polymerization)

2. A wired circuit board comprising a first insulating layer, a conductor layer laminated on the first insulating layer, and a second insulating layer interposed between the first insulating layer and the conductor layer, wherein the second insulating layer is formed from resin having a repeated unit expressed by at least either the following general formula (1) or (2), and a weight-average molecular weight in the range of 0.1×10⁵ to 1.5×10⁵:
Chemical Formula (1) 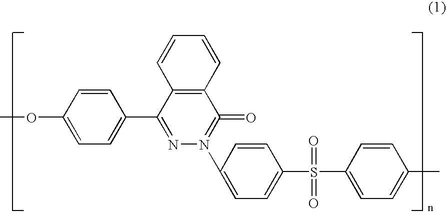
(n represents a degree of polymerization)
Chemical Formula (2) 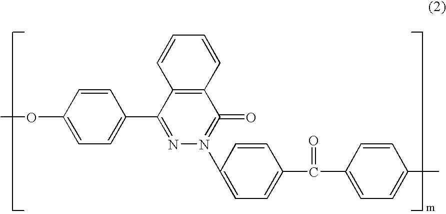
(m represents a degree of polymerization)

3. The wired circuit board according to claim 2, wherein the first insulating layer is formed from polyimide.
